(19) United States
(12) Patent Application Publication
(10) Pub. No.: US 2005/0065055 A1
(43) Pub. Date: Mar. 24, 2005

(54) Aqueous cleaning composition for hard surfaces

(76) Inventor: Jerry Barnes, Murray, UT (US)

Correspondence Address: THORPE NORTH & WESTERN, LLP., 8180 SOUTH 700 EAST, SUITE 200, P.O. BOX 1219, SANDY, UT, 84070, US

(21) Appl. No.: 10/666,706

(22) Filed: Sep. 19, 2003

(51) Int. Cl. C11D 17/00; C11D 17/08

(52) U.S. Cl. 510/421

(57) ABSTRACT

An aqueous cleaning composition for hard surfaces, which includes an inorganic acid, a surfactant and a lower alcohol solvent. Certain aspects of the present invention may also include an organic acid or a builder. The cleaning composition may include from about 0.01% to about 2% by weight of an inorganic acid such as sulfamic acid. Furthermore, a surfactant may be present in the cleaning composition with a concentration from about 0.01% to about 3% by weight. Examples of surfactants may be N,N-bis(hydroxyethyl)-cocoamide, dodecylbenzene sulfonic acid or a combination thereof. Additionally, a lower alcohol solvent such as isopropyl alcohol may be present with a concentration from about 1% to about 10% by weight. Certain aspects of the present invention may include an organic acid, such as hydroxyacetic acid. Finally, a builder may be present with a concentration of from about 0.005% to about 1% by weight. Examples of builders may include monoethanolamine, monoethanolammonium or combinations thereof.

### FIELD OF THE INVENTION

The present invention relates generally to cleaning compositions. Accordingly, the present invention involves the fields of inorganic and organic chemistry.

### BACKGROUND

Cleaning products are routinely used to remove soils from surfaces. Soils may be inorganic or organic in nature, and may include dirt particles, greases, oils, fats, food residues, cosmetics, paint, carbonates, soot, oxides, etc. The cleaner acts to loosen soils from the surface to be cleaned, and then to solubilize the soil material so that it may be removed with the cleaning solution.

Classes of cleaning products can be extremely diverse, ranging from general purpose cleaners that can be utilized to clean many different types of soils and stains on diverse surfaces, to specialized cleaners, such as glass, tile and toilet cleaners. Often the cleaning efficiency of the cleaner is decreased as it becomes more general, trading off efficiency for greater versatility. For example, glass cleaner may be formulated to specifically react with the types of soils found on glass, and in view of their particular interaction with the glass surface. General purpose cleaners, on the other hand, must be formulated to react with a wider variety of soils that will naturally have very diverse interactions, depending on the type of surface to be cleaned. As a result of this, general purpose cleaners capable of cleaning a variety of surfaces while maintaining increased cleaning efficiency are constantly being sought in the chemical cleaner industry.

### SUMMARY OF THE INVENTION

The present invention provides an aqueous cleaning composition for hard surfaces, which includes an inorganic acid, a surfactant and a lower alcohol solvent. Certain aspects of the present invention may also include additional ingredients such as an organic acid and/or a builder.

In one aspect of the present invention, an inorganic acid is present in the cleaning composition from about 0.01% to about 2% by weight. One preferred aspect of present invention may include sulfamic acid as the inorganic acid.

Furthermore, it is contemplated that a surfactant may be present in the cleaning composition with a concentration from about 0.01% to about 3% by weight. In a preferred aspect of the present invention, the surfactant may be N,N-bis(hydroxyethyl)-cocoamide, dodecylbenzene sulfonic acid or a combination thereof.

Additionally, a lower alcohol solvent may be present in the cleaning composition with a concentration from about 1% to about 10% by weight. In a preferred aspect of the present invention, the lower alcohol solvent is isopropyl alcohol.

In certain aspects of the present invention, an organic acid may be present in the cleaning composition from about 0.002% to about 0.1% by weight. Hydroxyacetic acid is one preferred organic acid in a preferred aspect of the present invention.

Finally, a builder may be present in certain aspects of the cleaning composition with a concentration from about 0.005% to about 1% by weight. In a preferred aspect of the present invention, the builder is monoethanolamine, monoethanolammonium or combinations thereof.

Additional features and advantages of the invention will be apparent from the detailed description which follows, taken in conjunction with the accompanying drawings, which together illustrate, by way of example, features of the invention.

### DETAILED DESCRIPTION

Reference will now be made to the exemplary embodiments and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The present invention may be embodied as an aqueous cleaning composition for cleaning hard surfaces, comprising, in appropriately functional amounts, an inorganic acid, a surfactant, a lower alcohol solvent and water. Additional aspects of the present invention may also include the addition of a builder and an inorganic acid. The cleaning composition may be dispersed via a trigger spray, squeeze bottle, aerosol spray, or any other method of dispersion known to one skilled in the art. The cleaning composition may also be distributed in a concentrated form to be diluted by the user without departing from the scope of the present invention.

Inorganic acids

One aspect of the present invention may include an inorganic acid to assist in removing organic and inorganic deposits from the surface being cleaned. Inorganic acids are particularly useful in the removal of rust, scale, hard water deposits such as carbonates and the like. Inorganic acids which may be considered functional include, but are not limited to, hydrochloric acid, sulfuric acid, sulfamic acid, sulfurous acid, persulfuric acid, phosphoric acid, nitric acid, nitrous acid, sodium bisulfate, potassium bisulfate, sodium mono-H and di-H ortho- and pyrophosphates and the like. It is also contemplated that combinations of different inorganic acids may be used within the scope of the present invention. Another aspect of the present invention may include sulfamic acid, sulfurous acid, sodium bisulfate, potassium bisulfate as an inorganic acid. In a preferred aspect of the present invention, however, sulfamic acid is included as the preferred inorganic acid.

One aspect of the present invention contemplates inorganic acid concentration ranges from about 0.01% to about 2% by weight of the total composition. Though this concentration range is functional, in one preferred aspect the inorganic acid concentrations may range from about 0.05% to about 1% by weight.

Surfactants

Surfactants are surface-active wetting and foaming agents. In one aspect of the present invention, a surfactant may be included in the cleaning composition selected from the general group consisting of sodium dodecylbenzene sulfonate, dodecylbenzene sulfonate, dodecylbenzene sulfonic acid, sodium laurylbenzene sulfonate, branched chain alkylaryl sulfonates, sodium xylene sulfonate, olefin sulfonates, hydroxyl C₁₀ to C₂₀ alkyl sulfonates, alpha sulfo methyl esters, alkyl polyglucosides, alcohol sulfates, alcohol ether sulfates, lauryl sarcosinate, fatty acid salts, alcohol ethoxylates, alkylphenol ethoxylates, lauryl amine oxide, nonylphenol ethoxylates, octylphenol ethoxylates, coconut diethanolamide, coconut-based surfactants dialkyl dimethyl ammonium chlorides, alkyl dimethyl ethylbenzyl ammonium chlorides, hexadecyl trimethyl ammonium bromide, quaternary ammonium chlorides, alkylbetain, N-carboxyethyl-N-alkylamido-ethylglycinate, N-alkylamido-propyl-N-dimethyl-aminoxid and combinations thereof.

It is intended that the surfactant compounds described herein include both acid salts and esters of the compound. For example, the description of a sulfonate compound would also include the sulfonic acid derivative of the compound.

In alternative aspects of the present invention, the surfactants may be utilized based on the general categories of anionic surfactants, cationic surfactants, nonionic surfactants and amphoteric surfactants. Examples of suitable anionic surfactants include, but are not limited to, sodium dodecylbenzene sulfonate, dodecylbenzene sulfonate, dodecylbenzene sulfonic acid, sodium laurylbenzene sulfonate, branched chain alkylaryl sulfonates, sodium xylene sulfonate, olefin sulfonates, hydroxy C₁₀ to C₂₄ alkyl sulfonates, alpha sulfo methyl esters, alkyl polyglucosides, alcohol sulfates, alcohol ether sulfates, lauryl sarcosinate, and fatty acid salts.

One aspect of the present invention may more specifically utilize a linear alkylbenzene sulfonate surfactant such as sodium dodecylbenzene sulfonate, dodecylbenzene sulfonate, dodecylbenzene sulfonic acid, and sodium laurylbenzene sulfonate. In one preferred aspect of the present invention, dodecylbenzene sulfonic acid may be used as a surfactant. Furthermore, linear alkylbenzene sulfonates are highly effective cleaners, particularly when used to remove fats and oils. And, as an additional benefit, these compounds are compatible with many other cleaning ingredients, particularly cationic surfactants. As a final note, overall effectiveness of these surfactants vary with chain length, generally peaking around 10-13 carbon atoms. Because the effectiveness of a surfactant in cleaning a particular type of organic or inorganic deposits may vary with chain length, a surfactant with a mixture of chain lengths may also be effective.

Another aspect of the present invention may utilize a branched chain alkylaryl sulfonate, particularly the alkylbenzene sulfonates, wherein the alkyl group contains from about 8 to 15 carbon atoms; the lower aryl or hydrotropic sulfonates such as sodium xylene sulfonate; the olefin sulfonates, such as those produced by sulfonating a C₁₀ to C₂₄ straight-chained olefin; hydroxy C₁₀ to C₂₄ alkyl sulfonates; water-soluble alkyl disulfonates containing from about 10 to 24 carbon atoms; the normal and secondary higher alkyl detergents, particularly those having about 8 to 15 carbon atoms in the alkyl residue such as lauryl or coconut fatty alcohol sulfate; sulfuric acid esters of polyhydric alcohols partially esterified with higher fatty acids such as coconut oil, monoglyceride, monosulfate coconut, ethanolamide sulfate, lauric acid amide or taurine, etc.; various soaps or salts of fatty acids containing from about 8 to 22 carbon atoms, such as sodium, potassium, ammonium and lower alkanol-amine, particularly mono-, di- and triethanolamine salts of fatty acids such as steric acid, oleic acid, coconut fatty acid, fatty acids derived from palm oil, soybean oil, tallow and the like. Preferred anionic surfactants from this group include the fatty alcohol and ether alcohol sulfates and the sodium salts of fatty acids containing from about 10 to 18 carbon atoms.

Other aspects of the present invention may utilize an alcohol ether sulfate such as a lauryl ether sulfate or a laureth sulfate. Additionally, an alcohol sulfate or a lauryl sarcosinate may be used. Alkane sulfonates may also be used, these compounds having the advantage of being compatible with chlorine in hypochlorite containing cleaners. Finally, fatty acid salts, or soap, may be useful in the composition as a surfactant, a sequestering agent or a solubilizer for marginally soluble ingredients such as pine oil.

Examples of suitable nonionic surfactants include, but are not limited to, alcohol ethoxylates, lauryl amine oxide, nonylphenol ethoxylates, octylphenol ethoxylates, coconut diethanolamide, coconut-based surfactants and combinations thereof.

One aspect of the present invention includes alcohol ethoxylates (also known as alkyl polyethylene glycol ethers) as nonionic surfactants. These surfactants may include, but are not limited to, linear alcohol ethoxylates, primary alcohol ethoxylates, ethoxylated alcohols, and alcohol polyethylene glycol ethers. This group of surfactants is contemplated to include a wide range of alcohol structures that would be considered functional, however the range C₁₂₋₁₈ is optimal for detergency.

Another aspect of the present invention may include the use of alkylphenol ethoxylates (also known as alkylphenol polyethylene glycol ethers) as nonionic surfactants. Alkylphenol ethoxylates are similar to alcohol ethoxylates in that they tend to be highly effective detergents, they are low-foaming, and, because they are nonionic, they are compatible with cationic surfactants.

Other aspects of the present invention may include the use of coconut-based nonionic surfactants, including various ethoxylated alcohols, lauryl ether sulfates, and cocoamides. Cocoamides may include, but are not limited to, coconut diethanolamide and N,N-bis(hydroxyethyl)-cocoamide. In one preferred aspect of the present invention, the coconut-based surfactant is N,N-bis(hydroxyethyl)-cocoamide.

Examples of suitable cationic surfactants include, but are not limited to, dialkyl dimethyl ammonium chlorides, alkyl dimethyl benzyl ammonium chlorides, alkyl dimethyl ethylbenzyl ammonium chlorides, hexadecyl trimethyl ammonium bromide, quaternary ammonium chlorides and combinations thereof.

In addition to acting as surfactants, certain cationic surfactants may be included in the cleaning solution to act as antimicrobial agents to disinfect the surface to be cleaned. As an example, quaternary ammonium compounds such as alkyl dimethylbenzyl ammonium chloride may be included to perform this function. Other examples of antimicrobial agents may include pine oil and quaternary ammonium compounds, such as dialkyl dimethylammonium chlorides and alkyl dimethylbenzylammonium chlorides.

Examples of amphoteric surfactants include, but are not limited to, alkylbetain, N-carboxyethyl-N-alkylamido-ethylglycinate, N-alkylamido-propyl-N-dimethyl-aminoxid and combinations thereof.

It is further contemplated that the surfactants designated herein do not represent an all-inclusive group, and that other surfactant compounds may be substituted without varying from the scope of the present invention. Also, it should be noted that these surfactants may be utilized singly or in combination with each other.

Finally, while surfactant concentrations ranging from about 0.01% to about 3% by weight of the total composition are functional, it is preferred to use concentrations of between about 0.05% to about 2% by weight, and most preferably from about 0.1% to about 1% by weight.

Lower Alcohol Solvents

Solvents may be added to the cleaning composition to facilitate the action of the detergents and acids in the removal of soil deposits. The polar action of a lower alkanol may help dissolve grease and oil. Solvents may also be included to act as an antimicrobial agent to disinfect the cleaning surface of bacteria, fungus, mildew, etc. One aspect of the present invention may include a lower alcohol solvent. The lower alcohol solvent may be unsubstituted, or it may be substituted with NH₂, NR₂, OH or SH where one or both R group is a C₁ to C₃ alkyl. Examples of lower alcohol solvents include, but are not limited to, methanol, ethanol, 2-amino ethanol, ethylene glycol, propanol, isopropanol, butanol, t-butanol and pentanol. The lower alcohol solvent may also consist of a combination of lower alcohols. In one aspect of the present invention, isopropanol is the preferred lower alcohol solvent. In another aspect of the present invention, from about 0.004% to about 0.013% of 2-amino ethanol may be added to the cleaning composition to improve performance.

Lower alcohol solvent concentrations are considered functional between about 1% to about 10% by weight, and are more preferable between about 1.5% and about 5% by weight, and are most preferable between about 2% and about 3% by weight.

Organic Acid

One aspect of the present invention may also include an organic acid. Examples of suitable organic acids include, but are not limited to, citric acid, acetic acid, hydroxyacetic acid (glycolic acid), oxalic acid and maleic acid. The organic acid may also consist of combinations of the above organic acids. In one preferred embodiment, hydroxyacetic and/or acetic acid may be used, and most preferably hydroxyacetic acid. The concentration of organic acid in the cleaning composition may be from about 0.002% to about 0.1% by weight.

Builder

Certain aspects of the present invention may include a builder to improve the performance of the surfactant. Builders often function to buffer pH, soften water and regulate foam height. Examples of suitable builders may include, but are not limited to sodium carbonate, sodium EDTA, sodium sulfate, sodium silicate, sodium citrate, sodium chloride, monoethanolamine, monoethanolammonium, sodium tripolyphosphate, sodium pyrophosphate and combinations thereof. A preferred aspect of the present invention may include monoethanolamine and/or monoethanolammonium as a suitable builder. Finally, the concentration of the builder, when present, is contemplated to be from about 0.005% to about 1% by weight.

### EXAMPLES

The following examples are provided to promote a more clear understanding of certain embodiments of the present invention, and are in no way meant as a limitation thereon.

### Example 1

An aqueous cleaning solution was prepared by mixing the following chemicals with 1 gallon of water to form the aqueous cleaning composition:

| Chemical | Final % by weight |
|---|---|
| Sulfamic Acid | 0.09-0.3% |
| Dodecylbenzene sulfonic acid | 0.1-0.75% |
| N,N-bis(hydroxyethyl)-cocoamide | 0.08-0.027% |
| 2-amino-ethanol | 0.004-0.01% |
| isopropyl alcohol | 1.5-1.8% |

### Example 2

An aqueous cleaning solution was prepared by mixing the following chemicals with 1 gallon of water to form the aqueous cleaning composition:

| Chemical | Final % by weight |
|---|---|
| Sulfamic Acid | 0.22% |
| Dodecylbenzene sulfonic acid | 0.25% |
| N,N-bis(hydroxyethyl)-cocoamide | 0.02% |
| 2-amino-ethanol | 0.008% |
| isopropyl alcohol | 1.8% |
| hydroxyacetic acid | 0.02% |
| monoethanolamine | 0.09% |

It is to be understood that the above-described compositions are only illustrative of preferred embodiments of the present invention. Numerous modifications and alternative arrangements may be devised by those skilled in the art without departing from the spirit and scope of the present invention and the appended claims are intended to cover such modifications and arrangements.

Thus, while the present invention has been described above with particularity and detail in connection with what is presently deemed to be the most practical and preferred embodiments of the invention, it will be apparent to those of ordinary skill in the art that numerous modifications, including, but not limited to, variations in quantity, specific chemicals, function and use may be made without departing from the principles and concepts set forth herein.

1. An aqueous cleaning composition for hard surfaces, comprising:
a) from about 0.01% to about 2% by weight of an inorganic acid;
b) from about 0.01% to about 3% by weight of a surfactant; and
c) from about 1% to about 10% by weight of a lower alcohol solvent.

2. The aqueous cleaning composition of claim 1, wherein:
a) the inorganic acid is selected from the group consisting of hydrochloric acid, sulfuric acid, sulfamic acid, sulfurous acid, persulfuric acid, phosphoric acid, nitrous acid, sodium bisulfate, potassium bisulfate and combinations thereof;
b) the surfactant is selected from the group consisting of sodium dodecylbenzene sulfonate, dodecylbenzene sulfonate, dodecylbenzene sulfonic acid, sodium laurylbenzene sulfonate, branched chain alkylaryl sulfonates, sodium xylene sulfonate, olefin sulfonates, hydroxyl C₁₀ to C₂₀ alkyl sulfonates, alkane sulfonates, alpha sulfo methyl esters, alkyl polyglucosides, alcohol sulfates, alcohol ether sulfates, lauryl sarcosinate, fatty acid salts, alcohol ethoxylates, alkylphenol ethoxylates, lauryl amine oxide, nonylphenol ethoxylates, octylphenol ethoxylates, coconut diethanolamide, coconut-based surfactants dialkyl dimethyl ammonium chlorides, alkyl dimethyl ethylbenzyl ammonium chlorides, hexadecyl trimethyl ammonium bromide, quaternary ammonium chlorides, alkylbetain, N-carboxyethyl-N-alkylamido-ethylglycinate, N-alkylamido-propyl-N-dimethyl-aminoxid and combinations thereof; and
c) the lower alcohol solvent is selected from the group consisting of methanol, ethanol, propanol, isopropanol, butanol, t-butanol, pentanol and combinations thereof.

3. The aqueous cleaning composition of claim 2, wherein the inorganic acid is sulfamic acid.

4. The aqueous cleaning composition of claim 2, wherein the concentration of the inorganic acid is from about 0.05% to about 1%.

5. The aqueous cleaning composition of claim 2, wherein the concentration of surfactant is from about 0.01% to about 3%.

6. The aqueous cleaning composition of claim 2, wherein the concentration of surfactant is from about 0.05% to about 2%.

7. The aqueous cleaning composition of claim 2, wherein the concentration of surfactant is from about 0.1% to about 1%.

8. The aqueous cleaning composition of claim 2, wherein the coconut-based surfactant is N,N-bis(hydroxyethyl)-cocoamide.

9. The aqueous cleaning composition of claim 2, wherein the lower alcohol solvent is selected from the group consisting of ethanol, propanol, isopropanol and combinations thereof.

10. The aqueous cleaning composition of claim 2, wherein the concentration of lower alcohol solvent is from about 1.5% to about 5%.

11. The aqueous cleaning composition of claim 2, wherein the concentration of lower alcohol solvent is from about 2% to about 3%.

12. The aqueous cleaning composition of claim 2, further comprising an organic acid.

13. The aqueous cleaning composition of claim 12, wherein the organic acid is selected from the group consisting of citric acid, acetic acid, hydroxyacetic acid, oxalic acid, maleic acid and combinations thereof.

14. The aqueous cleaning composition of claim 13, wherein the organic acid is hydroxyacetic acid.

15. The aqueous cleaning composition of claim 13, wherein the concentration of the organic acid is from about 0.002% to about 0.1%.

16. The aqueous cleaning composition of claim 2, further comprising a builder.

17. The aqueous cleaning composition of claim 16, wherein the builder is selected from the group consisting of sodium carbonate, sodium EDTA, sodium sulfate, sodium silicate, sodium citrate, sodium chloride, monoethanolamine, monoethanolammonium, sodium tripolyphosphate, sodium pyrophosphate and combinations thereof.

18. The aqueous cleaning composition of claim 17, wherein the builder is selected from the group consisting of monoethanolamine, monoethanolammonium and combinations thereof.

19. The aqueous cleaning composition of claim 17, wherein the concentration of the builder is from about 0.005% to about 1%.
